(19) United States
(12) Patent Application Publication
(10) Pub. No.: US 2013/0091015 A1
(43) Pub. Date: Apr. 11, 2013

(54) METHODS AND SYSTEMS FOR VIRTUAL VENDOR HAWKING USING DIRECTIONAL ADVERTISING

(71) Applicants: John Vijoe George, Champaign, IL (US); Jonathan Kilroy, Champaign, IL (US); Allie K. Watfa, Urbana, IL (US); Dale Nussel, Mahomet, IL (US)

(72) Inventors: John Vijoe George, Champaign, IL (US); Jonathan Kilroy, Champaign, IL (US); Allie K. Watfa, Urbana, IL (US); Dale Nussel, Mahomet, IL (US)

(73) Assignee: Yahoo! Inc., Sunnyvale, CA (US)

(21) Appl. No.: 13/269,383

(22) Filed: Oct. 7, 2011

(51) Int. Cl. G06Q 30/02

(52) U.S. Cl. 705/14.58

(57) ABSTRACT

Techniques are provided for use in targeting potential customers that may be travelling near a vendor. A set of one or more potential customers travelling in a predetermined direction within a predetermined distance from a vendor's geographic location may be detected substantially in real time. The vendor may specify one or more criteria to target the potential customers. The set of potential customers may be reduced based at least in part on the one or more criteria to create a subset of potential customers. One or more advertisements may be transmitted to the subset of potential customers such that the advertisements may be viewed or displayed or played back on the vehicle's sound system and/or on the occupants' smartphones.

### BACKGROUND

Advertisers (including proxies, agents, or other entities acting on behalf of or in the interest of advertisers) compete for user attention. One particular target audience of interest to advertisers is users who are travelling, whether on foot or in vehicles. Currently location based advertising is based on showing users all vendors that are located near or around the user's location.

There is a need for techniques to allow vendors to advertise to users who are travelling toward the vendors.

### SUMMARY

Exemplary embodiments of the invention provide methods and systems for targeting potential customers that are within a predetermined distance from a vendor. A set of one or more potential customers travelling in a predetermined direction within a predetermined distance from a vendor's geographic location may be detected substantially in real time. For example, a vendor may wish to detect how many potential customers are travelling towards the vendor within a 5 mile radius. In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art.

The vendor may be allowed to specify one or more criteria to target the potential customers. The criteria may include, for example, the type of mobile device being used, the type of vehicle the potential customer(s) are travelling in, the number of potential customers in a given group, etc. In some embodiments, real-time vehicle information may be obtained via one or more sensors in the vehicle and may be used to target potential customers. For example, gas stations may wish to target nearby vehicles that have at least half a tank of gas because these vehicles are not likely to stop to get gas but they may be persuaded if presented with an incentive such as a discount. In one embodiment, real-time vehicle information may include, for example, oil level, gasoline level, tire pressure, coolant level, windshield wiper fluid level, etc. The one or more sensors may transmit the vehicle information to, for example, the GPS navigation device (e.g., built-in vehicle navigation system, or mobile GPS navigation unit). The vehicle information may then be obtained by one or more servers and/or advertiser computers from the GPS device via the Internet.

The set of potential customers may be reduced based at least in part on the one or more criteria to create a subset of potential customers. For example, if it is determined that ten potential customers are near the vendor, the vendor may wish to target only a subset of those ten potential customers that are travelling towards the vendor.

One or more advertisements may be transmitted to the subset of potential customers. In some embodiments, if the potential customers are travelling in a vehicle, the one or more advertisements may be transmitted over a radio signal such that the audio advertisement(s) may be played on the vehicle's stereo system to allow all occupants of the vehicle to hear the advertisement. Alternatively, or in addition, the advertisement(s) may be transmitted such that a browser application on the users' smartphones may be directed to display the advertisement. In some embodiments, the advertisement(s) may be transmitted to the in-vehicle GPS navigation system and displayed on the navigation system.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

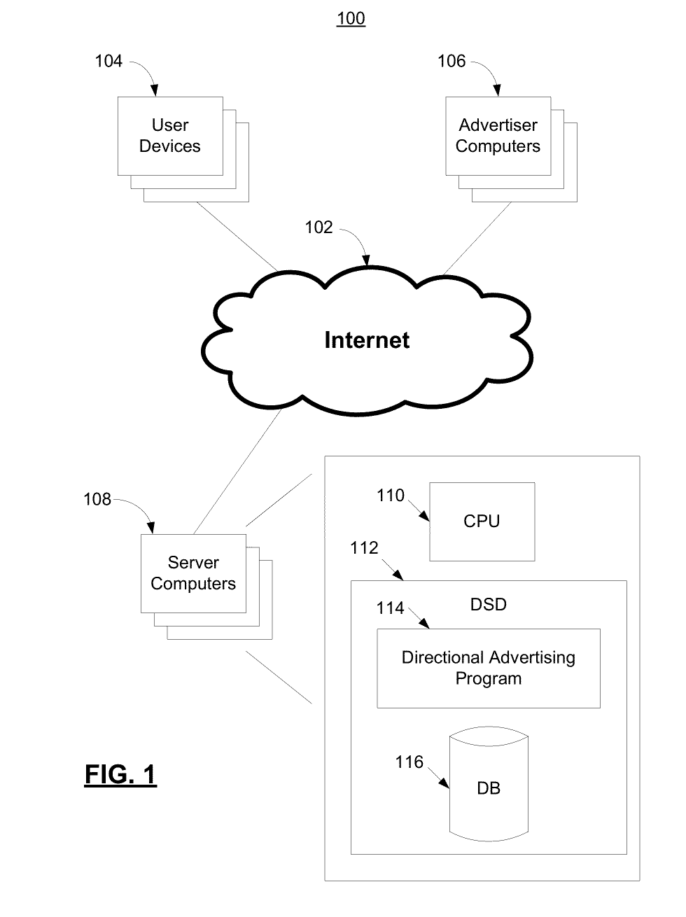

FIG. 1 is a distributed computer system 100 according to one embodiment of the invention. The system 100 includes user devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user devices 104 may be portable or handheld devices such as smart phones, PDAs, tablets, laptops, GPS navigation units, etc. In addition, user devices 104 may also include in-vehicle GPS navigation systems.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, graphical advertisements, rich advertisements, video advertisements, etc.

As depicted, each of the server computers 108 includes one or more CPUs 110 and a data storage device 112. The data storage device 112 includes a database 116 and a Directional Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

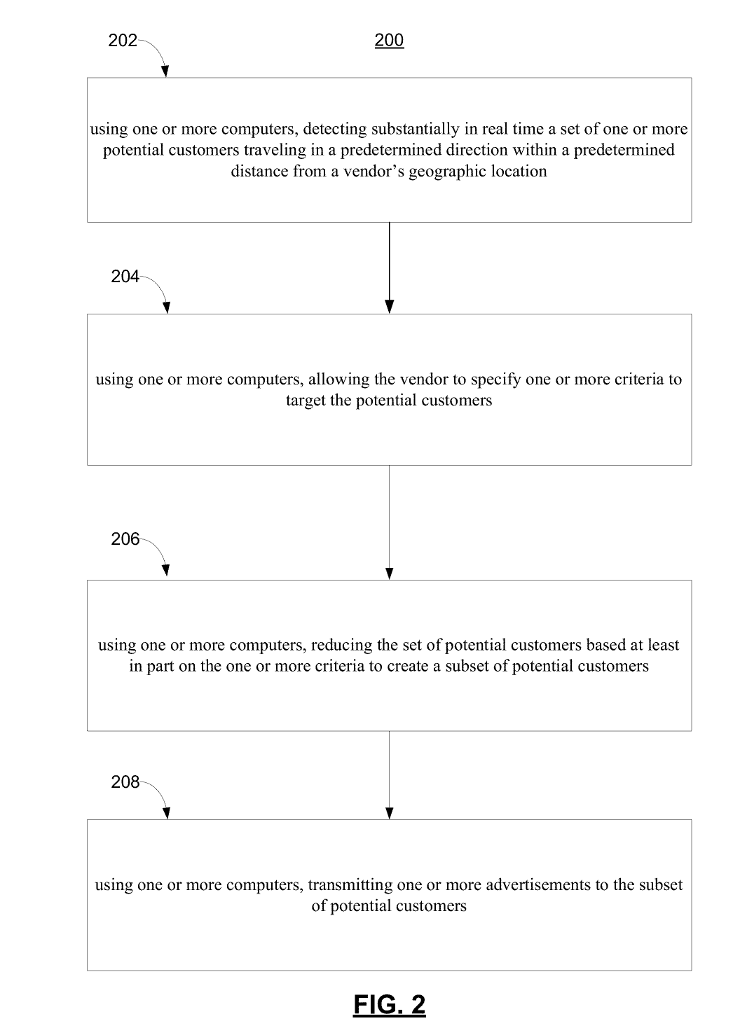

FIG. 2 is a flow diagram illustrating a method 200 according to one embodiment of the invention. At step 202, using one or more computers, a set of one or more potential customers travelling in a predetermined direction within a predetermined distance from a vendor's geographic location may be detected substantially in real time. For example, a vendor may wish to detect how many potential customers are travelling towards the vendor within a 5 mile radius. In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art.

At step 204, using one or more computers, the vendor may be allowed to specify one or more criteria to target the potential customers. The criteria may include, for example, the type of mobile device being used, the type of vehicle the potential customer(s) are travelling in, the number of potential customers in a given group, etc. In some embodiments, real-time vehicle information may be obtained via one or more sensors in the vehicle and may be used to target potential customers. For example, gas stations may wish to target nearby vehicles that have at least half a tank of gas because these vehicles are not likely to stop to get gas but they may be persuaded if presented with an incentive such as a discount. In one embodiment, real-time vehicle information may include, for example, oil level, gasoline level, tire pressure, coolant level, windshield wiper fluid level, etc. The one or more sensors may transmit the vehicle information to, for example, the GPS navigation device (e.g., built-in vehicle navigation system, or mobile GPS navigation unit). The vehicle information may then be obtained by one or more servers and/or advertiser computers from the GPS device via the Internet.

At step 206, using one or more computers, the set of potential customers may be reduced based at least in part on the one or more criteria to create a subset of potential customers. For example, if it is determined that ten potential customers are travelling toward the vendor, the vendor may wish to target only a subset of those ten potential customers based on one or more criteria.

At step 208, using one or more computers, one or more advertisements may be transmitted to the subset of potential customers. In some embodiments, if the potential customers are travelling in a vehicle, the one or more advertisements may be transmitted over a radio signal such that the audio advertisement(s) may be played on the vehicle's stereo system to allow all occupants of the vehicle to hear the advertisement. Alternatively, or in addition, the advertisement(s) may be transmitted such that a browser application on the users' smartphones may be directed to display the advertisement. In some embodiments, the advertisement(s) may be transmitted to the in-vehicle GPS navigation system and displayed on the navigation system.

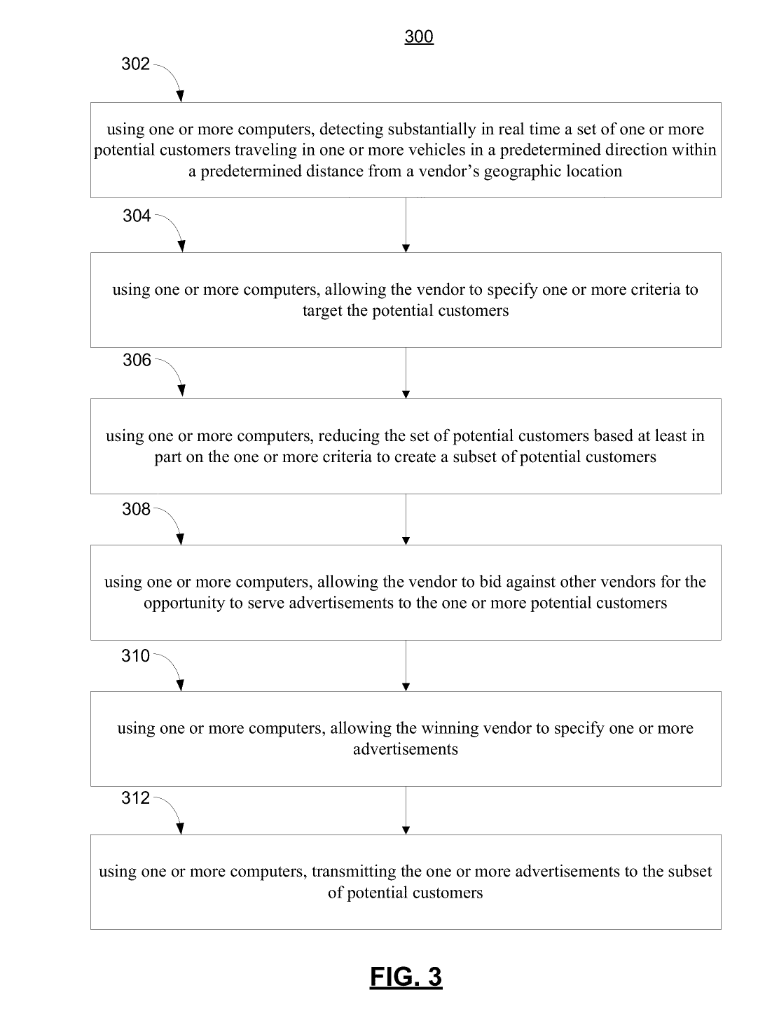

FIG. 3 is a flow diagram illustrating a method 300 according to one embodiment of the invention. At step 302, using one or more computers, a set of one or more potential customers travelling in a predetermined direction within a predetermined distance from a vendor's geographic location may be detected substantially in real time. For example, a vendor may wish to detect how many potential customers are travelling towards the vendor within a 5 mile radius. In accordance with an exemplary embodiment, the potential customers may be detected by for example tracking users' mobile devices. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art.

At step 304, using one or more computers, the vendor may be allowed to specify one or more criteria to target the potential customers. The criteria may include, for example, the type of mobile device being used, the type of vehicle the potential customer(s) are travelling in, the number of potential customers in a given group, etc. In some embodiments, real-time vehicle information may be obtained via one or more sensors in the vehicle and may be used to target potential customers. For example, gas stations may wish to target nearby vehicles that have at least half a tank of gas because these vehicles are not likely to stop to get gas but they may be persuaded if presented with an incentive such as a discount. In one embodiment, real-time vehicle information may include, for example, oil level, gasoline level, tire pressure, coolant level, windshield wiper fluid level, etc. The one or more sensors may transmit the vehicle information to, for example, the GPS navigation device (e.g., built-in vehicle navigation system, or mobile GPS navigation unit). The vehicle information may then be obtained by one or more servers and/or advertiser computers from the GPS device via the Internet.

At step 306, using one or more computers, the set of potential customers may be reduced based at least in part on the one or more criteria to create a subset of potential customers. For example, if it is determined that ten potential customers are travelling toward the vendor, the vendor may wish to target only a subset of those ten potential customers based on one or more criteria.

At step 308, using one or more computers, the vendor may be allowed to bid against other vendors for the opportunity to serve advertisements to the one or more potential customers. For example, in areas where a large number of similar vendors are located, a bidding system may allow vendors to bid against other vendors on potential advertisements. For example, for an off-ramp with many gas stations but only one hotel, the gas stations may bid against each other for the opportunity to have their advertisements served to nearby motorists. However, the hotel may not need to bid since the hotel is the only one in the area.

At step 310, using one or more computers, the winning vendor may be allowed to specify one or more advertisements. For example, the vendor may wish to advertise discounts, rewards, specials, or other incentives.

At step 312, using one or more computers, the one or more advertisements may be transmitted to the subset of potential customers. In some embodiments, if the potential customers are travelling in a vehicle, the one or more advertisements may be transmitted over a radio signal such that the audio advertisement(s) may be played on the vehicle's stereo system to allow all occupants of the vehicle to hear the advertisement. Alternatively, or in addition, the advertisement(s) may be transmitted such that a browser application on the users' smartphones may be directed to display the advertisement. In some embodiments, the advertisement(s) may be transmitted to the in-vehicle GPS navigation system and displayed on the navigation system.

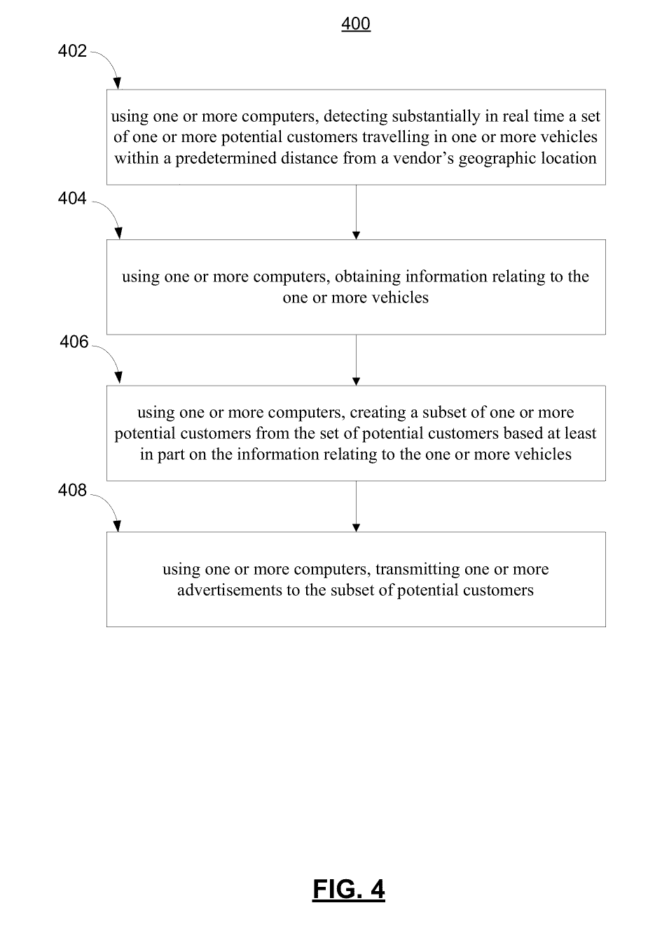

FIG. 4 is a flow diagram illustrating a method 400 according to one embodiment of the invention. At step 402, using one or more computers, a set of one or more potential customers travelling in one or more vehicles within a predetermined distance from a vendor's geographic location may be detected substantially in real time.

At step 404, using one or more computers, information relating to the one or more vehicles may be obtained. For example, vehicle information may include, for example, oil level, gasoline level, tire pressure, coolant level, windshield wiper fluid level, etc. The one or more sensors may transmit the vehicle information to, for example, the GPS navigation device (e.g., built-in vehicle navigation system, or mobile GPS navigation unit). The vehicle information may then be obtained by one or more servers and/or advertiser computers from the GPS device via the Internet.

At step 406, using one or more computers, a subset of one or more potential customers may be created from the set of potential customers based at least in part on the information relating to the one or more vehicles. For example, gas stations may wish to target nearby vehicles that have at least half a tank of gas because these vehicles are not likely to stop to get gas but they may be persuaded if presented with an incentive such as a discount.

At step 408, using one or more computers, one or more advertisements may be transmitted to the subset of potential customers. The one or more advertisements may be transmitted over a radio signal such that the audio advertisement(s) may be played on the vehicle's stereo system to allow all occupants of the vehicle to hear the advertisement. Alternatively, or in addition, the advertisement(s) may be transmitted such that a browser application on the users' smartphones may be directed to display the advertisement. In some embodiments, the advertisement(s) may be transmitted to the in-vehicle GPS navigation system and displayed on the navigation system.

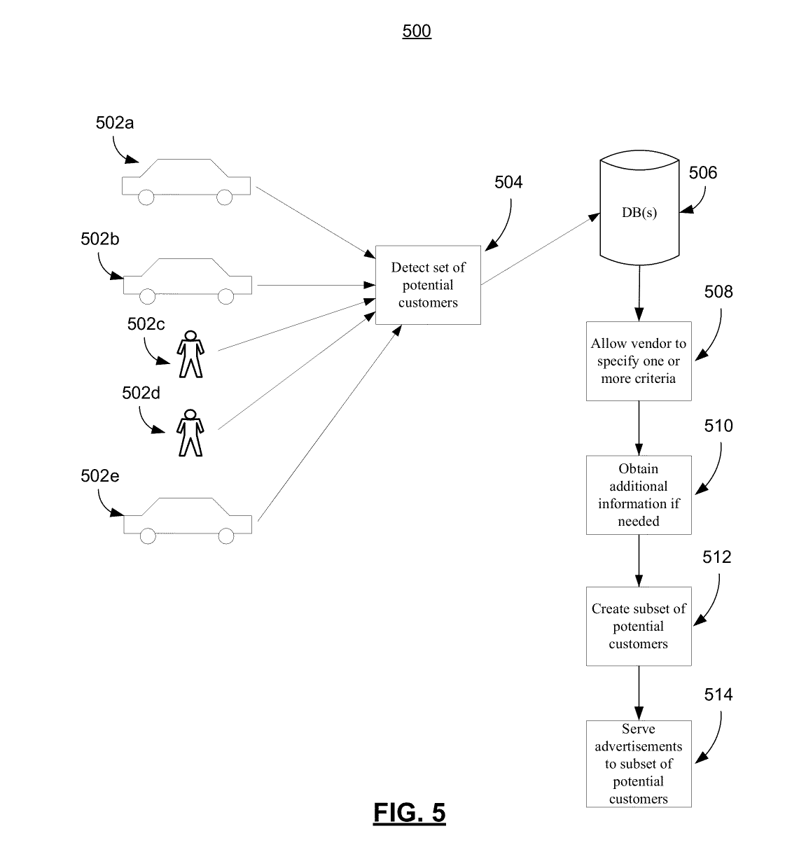

FIG. 5 is a block diagram 500 illustrating one embodiment of the invention. One or more data stores or databases 506 are depicted. Database 506 may be implemented on, for example, one or more server computers 108 (FIG. 1) and/or one or more advertiser computers 106 (FIG. 1). Various types of information are stored in the database 506. In particular, types of information stored in the database 506 include, potentially among many other types of information, device information, vehicle information, location information, etc. For example, the information may be stored in a table such as:

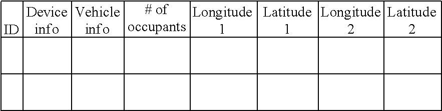

The information stored in database 506 may be obtained, gathered, or generated in various ways from various sources. For example, ID may be an arbitrary designation generated locally and used to identify potential customers. Vehicle info, which may include information such as gasoline level, oil level, etc., may be gathered from vehicle sensors as previously described. Device may include information relating to a user's mobile device such as a smartphone, and the information may include, for example, the make and model of the phone, the type of operating system, etc. The # of occupants field may include the number of occupants that are present in the vehicle. This may be detected using, for example, GPS signals from their respective mobile devices. For example, if multiple devices are detected in close proximity to each other, it may be inferred that those users are travelling together in the same vehicle. The longitude and latitude fields may be used to determine the location of potential customers and to determine if the potential customers are travelling toward or away from a vendor. For example, if location 1, which comprises longitude 1 and latitude 1, is farther away than location 2, which comprises longitude 2 and latitude 2, it may be inferred that the potential customer is travelling toward the vendor.

Block 504 represents detection of a set of one or more potential customers 502a-502e. The potential customers may be travelling in one or more vehicles or may be travelling on foot (e.g., walking in a shopping mall or airport). In accordance with an exemplary embodiment, the potential customers may be detected by for example tracking users' mobile devices. For example, all potential customers within a one mile radius from the vendor may be detected. This set of customers may then be reduced to a subset based on one or more criteria as described in further detail below. The mobile devices may include smart phones, PDAs, tablets, laptops, GPS navigation units, etc. In addition, the mobile devices may also include in-vehicle GPS navigation systems. The devices may be tracked using GPS enabled radios which are common in modern mobile devices. Alternatively, or in addition, the mobile devices may also be tracked using triangulation techniques that would be apparent to one of ordinary skill in the art. The information collected may be stored in a table in database 506, as described above.

As depicted in block 508, the vendor may be allowed to specify one or more criteria to target the potential customers. The criteria may include, for example, the type of mobile device being used, the type of vehicle the potential customer(s) are travelling in, the number of potential customers in a given group, whether the potential customer is travelling toward the vendor, etc. For example, a vendor may wish to detect how many potential customers are travelling towards the vendor within a 5 mile radius.

As depicted in block 510, additional may be obtained if needed based on the criteria specified by the vendor. For example, if the vendor wishes to target customers travelling in vehicles that have at least half a tank of gas, vehicle gasoline level information may need to be obtained via the vehicle's sensors. In some embodiments, real-time vehicle information may be obtained via one or more sensors in the vehicle and may be used to target potential customers. In some embodiments, real-time vehicle information may include, for example, oil level, gasoline level, tire pressure, coolant level, windshield wiper fluid level, etc. The one or more sensors may transmit the vehicle information to, for example, the GPS navigation device (e.g., built-in vehicle navigation system, or mobile GPS navigation unit). The vehicle information may then be obtained by one or more servers and/or advertiser computers from the GPS device via the Internet.

As depicted in block 512, a subset of potential customers may be created from the set of potential customers based at least in part on the one or more criteria. For example, if it is determined that ten potential customers are near the vendor, the vendor may wish to target only those customers that are travelling towards the vendor.

As depicted in block 514, one or more advertisements may be transmitted to the subset of potential customers. In some embodiments, if the potential customers are travelling in a vehicle, the one or more advertisements may be transmitted over a radio signal such that the audio advertisement(s) may be played on the vehicle's stereo system to allow all occupants of the vehicle to hear the advertisement. Alternatively, or in addition, the advertisement(s) may be transmitted such that a browser application on the users' smartphones may be directed to display the advertisement. In some embodiments, the advertisement(s) may be transmitted to the in-vehicle GPS navigation system and displayed on the navigation system.

In accordance with an exemplary embodiment, a vendor may specify an advertisement and/or deal and target information for the type of potential customer the vendor wishes to target. In addition, potential customers may be allowed to filter advertisements such that only certain types of advertisements and/or deals are shown to them. Moreover, advertisements may also be censored for certain customers (e.g., based on age profile).

The exemplary information described above may be used independently, or in combination, to vendors to target potential customers with advertisements. In accordance with exemplary embodiments, some use case scenarios will now be described.

One example is a restaurant located on an Interstate off-ramp. After the noon lunch rush, activity has died down for the restaurant, with few customers still remaining To encourage some additional afternoon sales, the restaurant will log into the system to see a summary of vehicles heading their way, and create a spontaneous ad for 10% off pie servings if 10 vehicles will independently agree to stop into the restaurant in the next 10 minutes. The system routes the ad out to the vehicle occupants heading toward the restaurant that would be able to arrive within 10 minutes. This targeted ad is not shown to vehicles already past the restaurant location and heading away from the restaurant.

Another example is a gas station on an Interstate off-ramp. Manager wants to increase sales, logs into the system and can obtain information on fuel tank levels for vehicles heading toward the Gas station location. The manager creates a spontaneous ad that offers a $0.01 discount on a gallon of gas for the first 20 vehicles which come in and sends the ad to the vehicles that contain less than ¼ tank of gas. The manager also enters a second ad for $0.02 discount on gallon of gas for the first 5 vehicles that arrive and targets it to vehicles that contain tanks which are over ½ full. The ad is sent out to vehicles within 2 miles from the gas station and heading toward the station.

Another example is a hotel next to an interstate. Room bookings are down for the night and manager wants to increase them. Manager logs into the system and views potential customers heading toward the hotel within 30 miles from the hotel. He offers a discounted price for the next 20 mins for 5 vehicles if they agree to stop. The ad is sent out to vehicles within the 30 mile radius that are heading toward the hotel.

In yet another example, a special 10 minute sale at one of the stores of a large mall can be advertised to customers around the mall and especially to customers walking toward the vendor.

While the invention is described with reference to the above drawings, the drawings are intended to be illustrative, and the invention contemplates other embodiments within the spirit of the invention.

1. A method comprising:
using one or more computers, detecting substantially in real time a set of one or more potential customers travelling in a predetermined direction within a predetermined distance from a vendor's geographic location;
using one or more computers, allowing the vendor to specify one or more criteria to target the potential customers;
using one or more computers, reducing the set of potential customers based at least in part on the one or more criteria to create a subset of potential customers; and
using one or more computers, transmitting one or more advertisements to the subset of potential customers.

2. The method of claim 1, further comprising:
using one or more computers, selecting the one or more advertisements based at least in part on the one or more criteria.

3. The method of claim 1, wherein transmitting the one or more advertisements comprises transmitting the one or more advertisements over a radio signal.

4. The method of claim 1, wherein transmitting the one or more advertisements comprises transmitting the one or more advertisements to one or more mobile devices belonging to the subset of potential customers.

5. The method of claim 4, wherein a browser application on the one or more mobile devices is directed to display the one or more advertisements.

6. The method of claim 1, wherein the advertisement comprises at least one of textual, graphical, audio and video data.

7. The method of claim 1, further comprising:
using one or more computers, allowing the vendor to bid against other vendors for the opportunity to serve advertisements to the one or more potential customers.

8. The method of claim 1, wherein the one or more potential customers are travelling in one or more vehicles.

9. The method of claim 1, wherein the one or more potential customers are travelling by foot.

10. A system comprising:
one or more server computers coupled to a network; and
one or more databases coupled to the one or more server computers;
wherein the one or more server computers are for:
detecting substantially in real time a set of one or more potential customers travelling in a predetermined direction within a predetermined distance from a vendor's geographic location;
allowing the vendor to specify one or more criteria to target the potential customers;
reducing the set of potential customers based at least in part on the one or more criteria to create a subset of potential customers; and
transmitting one or more advertisements to the subset of potential customers.

11. The system of claim 10, wherein the one or more server computers are further configured for:
selecting the one or more advertisements based at least in part on the one or more criteria.

12. The system of claim 10, wherein transmitting the one or more advertisements comprises transmitting the one or more advertisements over a radio signal.

13. The system of claim 10, wherein transmitting the one or more advertisements comprises transmitting the one or more advertisements to one or more mobile devices belonging to the subset of potential customers.

14. The system of claim 13, wherein a browser application on the one or more mobile devices is directed to display the one or more advertisements.

15. The system of claim 10, wherein the advertisement comprises at least one of textual, graphical, audio and video data.

16. The system of claim 10, wherein the one or more server computers are further configured for:
allowing the vendor to bid against other vendors for the opportunity to serve advertisements to the one or more potential customers.

17. The system of claim 10, wherein the one or more potential customers are travelling in one or more vehicles.

18. The system of claim 10, wherein the one or more potential customers are travelling by foot.

19. The system of claim 10, wherein the one or more server computers are further configured for:
allowing the vendor to specify the one or more advertisements.

20. A computer readable medium or media containing instructions for executing a method comprising:
using one or more computers, detecting substantially in real time a set of one or more potential customers travelling in one or more vehicles in a predetermined direction within a predetermined distance from a vendor's geographic location;
using one or more computers, allowing the vendor to specify one or more criteria to target the potential customers;
using one or more computers, reducing the set of potential customers based at least in part on the one or more criteria to create a subset of potential customers;
using one or more computers, allowing the vendor to bid against other vendors for the opportunity to serve advertisements to the one or more potential customers;
using one or more advertisements, allowing the winning vendor to specify one or more advertisements; and
using one or more computers, transmitting the one or more advertisements to the subset of potential customers.
